(19) United States
(12) Patent Application Publication
(10) Pub. No.: US 2004/0167835 A1
(43) Pub. Date: Aug. 26, 2004

(54) Record keeping system supporting tax determination

(76) Inventor: Jyh-Ching Yaur, Draper, UT (US)

Correspondence Address: Siemens Corporation, Intellectual Property Department, 170 Wood Avenue South, Iselin, NJ, 08830, US

(21) Appl. No.: 10/670,456

(22) Filed: Sep. 25, 2003

Related U.S. Application Data
(60) Provisional application No. 60/449,383, filed on Feb. 24, 2003.

(51) Int. Cl. G06F 17/60

(52) U.S. Cl. 705/31

(57) ABSTRACT

A system creates records identifying items supporting tax determination. The system includes an input processor for receiving information identifying a service provided to a specific entity and to be at least partially paid for by said specific entity. A data processor automatically, identifies the type of the service identified in the received information and allocates a predetermined tax related identification code to the service based on the service type and incorporating the allocated code, together with information identifying the service, in data representing a record. An output processor processes the data representing the record for output in response to a user command.

The present Utility patent application is based on Provisional patent application No. 60/449,383, filed on Feb. 24, 2003.

### FIELD OF THE INVENTION

The present invention relates generally to the field of tax and financial data processing, and more particularly to systems that facilitate the sharing, storing and reporting of tax documentation.

### BACKGROUND OF THE INVENTION

The United States Tax Code is a large and complex document having tens of thousands of pages. The record keeping requirements imposed by the ever changing tax laws are extensive and burdensome, and many services rendered by individuals and enterprises, such as healthcare providers, have significant tax implications which are either not readily appreciated by, or not accessible to, many consumers, such as patients and/or those paying for healthcare services. Furthermore, most patients at hospitals and dental offices have medical insurance or are the beneficiary of some form of third party reimbursement, further complicating tax issues.

Prior record keeping systems have attempted to address the problem of tracking tax deductible expenses, such as medical expenses, by means of entirely manual processes. Such manual systems require the tracking of direct expenses, and of insurance benefits and other reimbursements for such expenses. After the information is manually gathered, either automated or manual methods are used to tabulate and consolidate the data. A manual system requires substantial dedicated record keeping. In the case of healthcare services, information from different entities often appears on different forms and is not formatted for ready access by others.

Tax related data management systems also exist which address various data gathering and data access issues. Such data processing systems link tax information to forms to be filed with the Internal Revenue Service. While such systems address various aspects of tax data integration, they are generic tax systems that do not address the problem of gathering and categorizing e.g. medical expenses in a manner which could be later utilized by such tax preparation programs. There are other systems for processing medical expenses. However, such systems do not enable users to transform medical expense information into a format or protocol that would be useful in generating tax data.

A need exists for a system that provides an automated method for gathering and organizing expenses for services rendered to a consumer, such as medical and/or dental expenses from healthcare providers, as well as other related goods and services providers, and to capture and present this information in a manner that is useful to both consumers, i.e. patients, and tax professionals during the preparation and filing of tax returns.

### BRIEF SUMMARY OF THE INVENTION

In accordance with principles of the present invention, a system creates records identifying items supporting tax determination. The system includes an input processor for receiving information identifying a service provided to a specific entity and to be at least partially paid for by said specific entity. A data processor automatically, identifies the type of the service identified in the received information and allocates a predetermined tax related identification code to the service based on the service type and incorporates the allocated code, together with information identifying the service, in data representing a record. An output processor processes the data representing the record for output in response to a user command.

Such a system permits healthcare providers, such as physicians, hospitals and dental offices, to readily capture medical related expenses, and to provide that information to patients and tax professionals in either a hardcopy format or in an electronic form. The automated nature of the present system reduces the need for data entry and the opportunity for human errors as often occur, for example, during data transcription.

The present invention performs two basic functions, namely the gathering of expense data and the exchange of that information with others. A special tag or identifier is assigned to a tax sensitive expense within the expense record. The tag permits a healthcare provider, credit card company or any business entity to readily identify such expenses for later processing and the generation of relevant reports. Third party payments such as insurance benefits are also tracked by this method. Healthcare providers or other entities can either print information and forward the material by traditional postal services, or forward the information via an electronic form such as an Extended Markup Language (XML) file. Consumers or tax professionals are then able to import the tax related information into a tax processing application for use in preparing a tax return or other financial report.

Users of the system are typically able to reduce their tax liability and reduce tax reporting errors by being made aware of every tax related expense. By making the provided healthcare services appear less costly to patients, the potential for greater utilization of those services exists. The medical expense data, whether related to patient payments, guarantor payments or charge information, is presented in a single consolidated view that permits users of the system to more readily appreciate their actual cash flow and tax burden.

### BRIEF DESCRIPTION OF THE DRAWINGS

FIG. 1 is a schematic block diagram illustrating system data flow of the record system of the present invention;

FIG. 2 is a flow chart depicting data importing and exporting functions performed during utilization of the system depicted in FIG. 1;

FIG. 3 is an XML program listing of an electronic form by which data is exported from the system depicted in FIG. 1; and

FIG. 4 is an embodiment of a printed form by which data generated with the system of FIG. 1 is presented to an end user.

### DETAILED DESCRIPTION

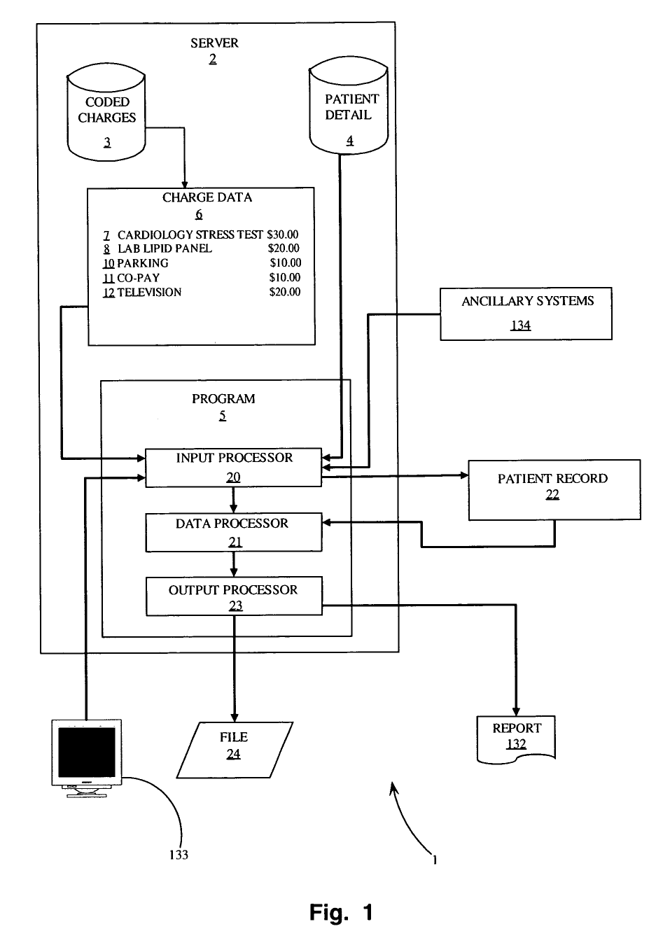

Referring to FIG. 1, a block diagram of a healthcare record keeping system 1 is seen to include a server computer 2. As used herein, the term “server” refers to a computer which stores information and provides the stored information to other computers, termed client computers. Therefore, server systems are responsible for receiving information requests from other computers, performing the data processing needed to satisfy those requests, and forwarding the results or information requested to the requesting computer. In the present system 1, the server 2 includes data storage devices 3 and 4 which store information that is utilized by the record keeping and report generating program 5.

Charges that may possibly be incurred by a consumer of services offered by a business, such as a hospital, dentist, or physician, or other enterprise such as a credit card company or educational institution have associated records which reside within storage device 3. Each such charge may or may not have some tax related significance. For example, dependent care expenses may or may not be tax deductible. In addition, some such charges may have a fixed, known amount associated with it. In a hospital environment each service typically has a standard, unchanging charge associated with that service. While the specific manner of data storage within storage device 3 may take any of many formats, the charge data resembles in some form the table 6 which includes a listing of line items such as lines 7, 8, 10 and 11. Some of the charges, such as the charge on line 12 for television service during an inpatient stay may have no tax significance, while other charges such as a stress test 7 may be completely or partially tax deductible.

As services are rendered to a patient, data representing those services are sent to the server 1. This data may be generated by any of numerous local or remote organizations. Local organizations include the hospital, dentist and/or physicians' offices where services are performed, represented by computer terminal 133. Remote organizations include ancillary facilities, each including a client computer system 134, such as laboratories, pharmacies, etc. The service representative data is sent to the input processor 20 which is a module or subroutine of program 5. The charge data 6 in storage device 3 is also made available to an input processor 20. In addition, other relevant patient data such as patient identification, insurance and guarantor data, is made available from a storage device 4 to input processor 20. In input processor 20 the actual cost of each service may be calculated and assigned to a patient record 22. The patient record 22, thus, contains data representing a list of charges incurred by that patient, and the amounts of each of those charges.

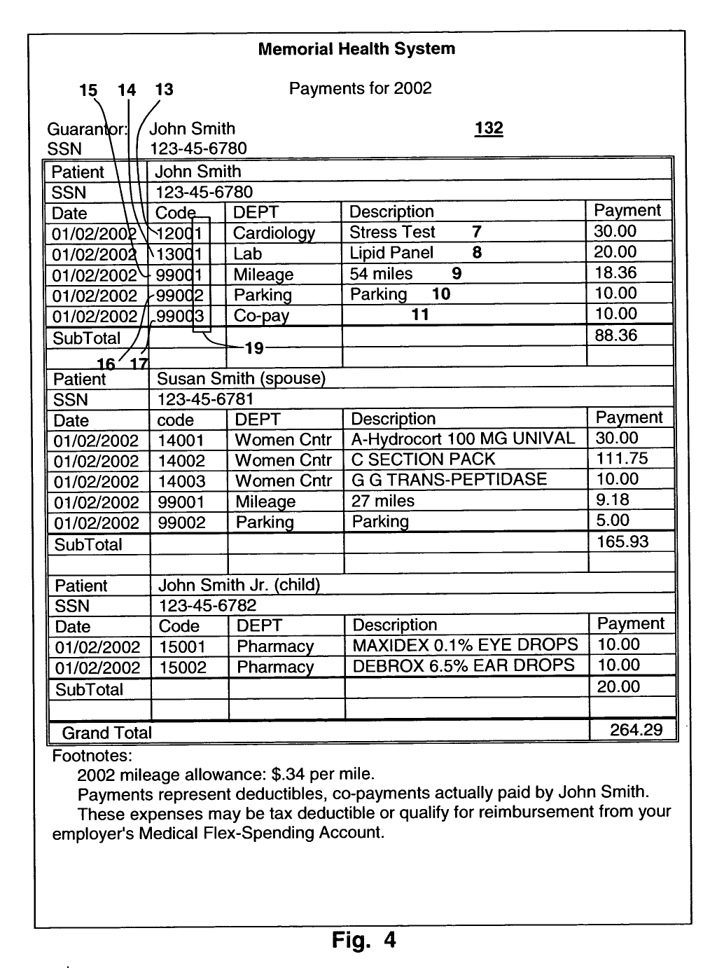

Referring now also to FIG. 4, data processor 21 (of FIG. 1), which is also a subroutine of program 5, allocates a unique predetermined code, such as codes 13, 14, 15, 16, and 17, to each associated charge line item 7, 8, 9, 10 and 11 stored in the patient record 22. In the illustrated embodiment, each code includes several digits that in combination identify relevant information such as the department rendering the service, whether the service was associated with an inpatient or outpatient visit, tax consequences, etc. A part of the code, which in the illustrated embodiment consists of one or more of the digits in the code 13, 14, 15, 16 and 17, identifies the associated expense as having a taxable significance. More specifically, in the illustrated embodiment, the existence of a digit in the fifth column 19 of the code 7 indicates that the expense has tax related significance, and the value of the digit appearing in column 19 indicates the nature or category of the tax significance, such as whether or not the expense is fully or partially deductible, whether the expense has been fully or partially reimbursed, or whether the expense is related to transportation costs incurred by the consumer in obtaining the service, and so forth.

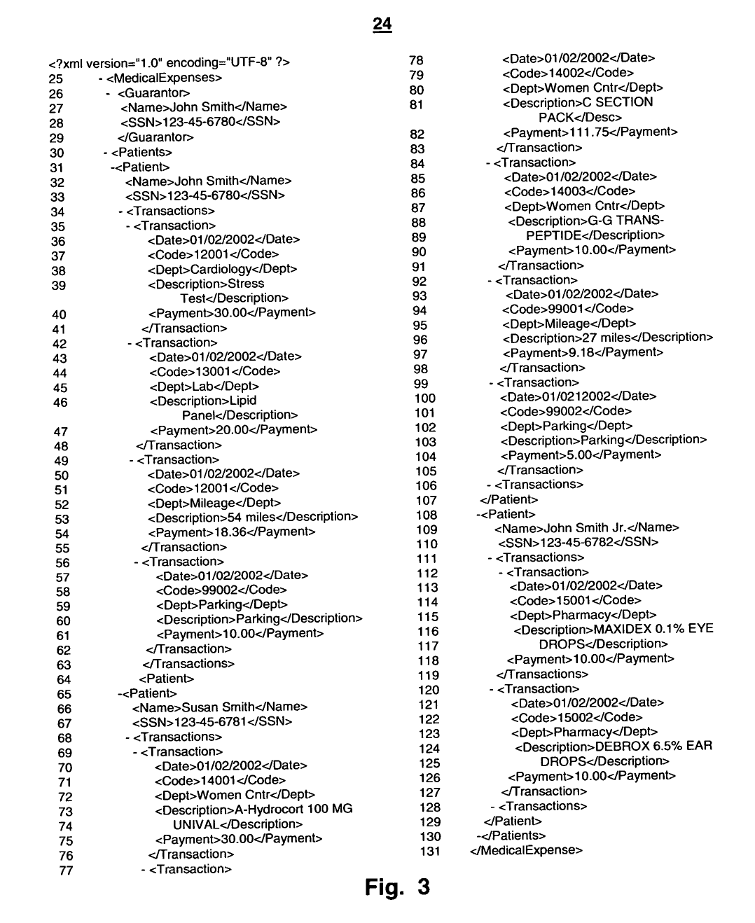

The data processor 21 correlates the data in the line item records 7, 8, 9, 10 and 11 in the patient record 22 with taxable expenses and forwards the correlated data to an output processor 23 residing within the program 5. The output processor 23 creates a report intended to be used by a consumer or tax professional in determining the tax liability of the consumer. This report may take several forms, such as a computer readable form or a human readable form. Referring now to FIG. 3, an XML file listing 24 is shown that depicts an electronic format for supplying the tax information created by the output processor 23. The title of the report, “Medical Expenses”, appears at line 25. The guarantor information appears at lines 26 through 29. A guarantor is a person or organization who promises to pay or guarantees payment for the portion of the patient's health related services not covered by the patient's insurance plan. Guarantors typically include the patient, relatives, friends, an employer, a court and/or a trust. The patient information is listed at lines 30 through 33. In the illustrated report, the patient is also the guarantor. Each separate transaction for this patient is set forth in lines 34 through 63. Codes described above assigned by the data processor 21 that identify the charges as tax related appear at lines 37, 44, 51 and 58. A second patient (spouse) having the same guarantor is identified on the same report 24 between lines 64 and 67. Transactions pertaining to the second patient appear at lines 68 through 106. A third patient (son) having the same guarantor is identified at lines 107 through 110. The services having tax implications that have been rendered for the third patient appear at lines 111 through 130. FIG. 4 depicts a medical expense report form 132 generated by output processor 23 in a printed or hardcopy form. Either of these reports may be used by a tax preparer to assist in preparing tax return forms.

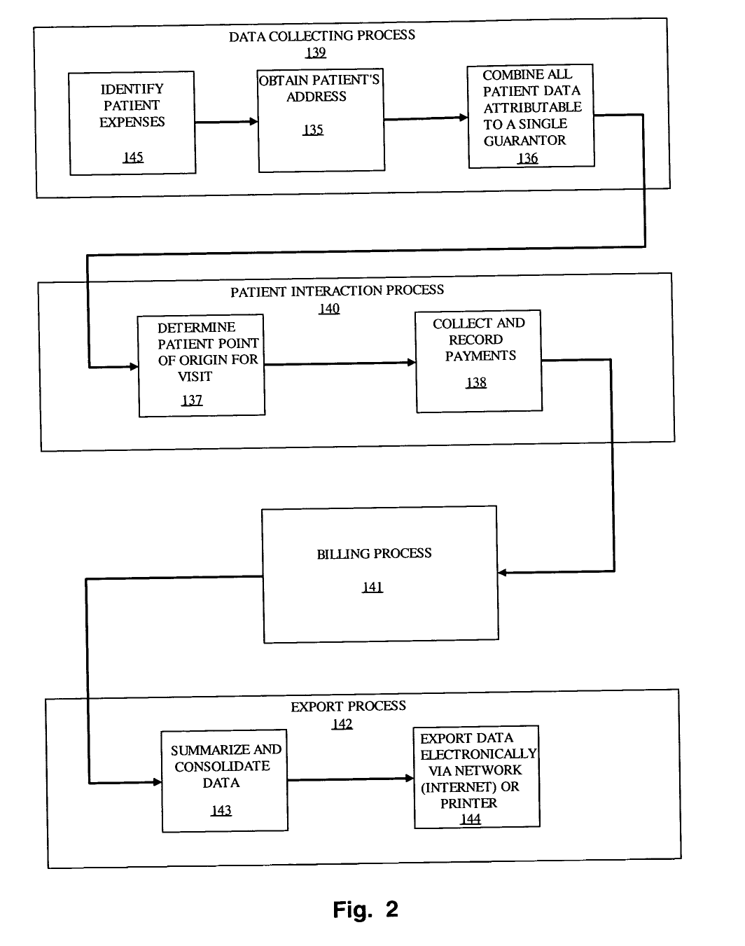

Referring to FIG. 2, the steps involved in using the system 1 may be understood. Input processor 20 receives information identifying a service provided to a patient during a data collecting process 139. At step 145 a user of the system 1, for example a billing clerk, identifies, in a known manner, the service which was rendered to a patient, for example a ‘per-visit co-payment’, or a ‘prescription’. An expense which is to be at least partially paid for by the patient (or consumer) is identified in this manner. The data processor 21, receives this information and identifies the type of service which was provided to the patient. For example, services types may include: medical services, dental services, educational services, dependent care expenses, etc. The service types may also include subtypes, for example in-patient and out-patient services for medical services rendered by a hospital. The records in the table 6 (FIG. 1) are further accessed to determine the tax related identification code (13, 14, 15, 16 17) associated with that type of service. This tax identification code is then incorporated into the line item record 7, 8, 9 etc. of FIG. 4. These codes may be used to separate potentially tax deductible items from other payments, such as reimbursements received from an insurance company. At step 135, the patient's home and work address is obtained from the patient detail record 4 (of FIG. 1) in order to permit data processor 21 to automatically calculate the driving distance to the healthcare facility, which may be eligible for a per mile tax deduction or credit. The data for an entire family (e.g. having a single guarantor) may then combined at step 136. This step permits the creation of a single multiple patient report such as shown in FIG. 4.

The patient interaction process 140 occurs during a patient visit to a healthcare facility. At step 137 the point of origin for this particular visit is determined in order to calculate the driving distance. Any payments due are collected and recorded at step 138. Mileage and payment information is supplied to the input processor 20 (of FIG. 1) where it is incorporated into the line item records in the patient record 22. Data representing recorded payments is made available for use during the billing process 141 performed by data processor 21. The billing process 141 operates to determine the guarantor of unpaid or unreimbursed expenses and to generate a bill for that guarantor, in a known manner. The report generation and export process 142 takes the billing data, integrates it with other available data and generates reports, either electronic or printed when requested by a user of the system 1. At step 143 the output processor 23 summarizes and consolidates the data needed to prepare either a tax deductible expense report 132, as illustrated in FIG. 4, or a report file 24, as illustrated in FIG. 3. As described above, and illustrated in the charge table 6 (of FIG. 1), services may be associated with an amount. In step 143, the output processor 23 may also accumulate the amounts associated with the consolidated expenses and generate a cumulative total of those charges on the report. The report or file is printed or exported at step 144. The electronic report may be in the form of a file which is suitable for electronic communication, e.g. via the internet.

The system 1 has been described above as being implemented in a healthcare system. However, such a system 1 is applicable to any entity that processes financial information for a customer that includes items subject to potentially differing tax treatment. For example, the system 1 may be used by pharmacies, retailers, educational organizations or credit and debit card processing companies. These entities may include healthcare provider organizations, groups of physicians or individuals. The system 1 permits any entity to provide periodic reports to a customer identifying categorized expenditures, including for example the identification of associated mileage or other transportation related costs. A header or footer may be included with each report 132 that includes further information which might be important in the use of such a report. For example, as illustrated in FIG. 4, a statement such as “These expenses may be tax deductible or qualify for reimbursement from your employer's Medical Flex-Spending Account”, or are “subject to potentially different tax treatment” may be included.

Such a statement may also be selectively included depending on the data placed in the report, such as including a statement indicating the per-mile allowance for automobile transportation if an automobile mileage line item is included in the report. Or the system 1 can track, and so indicate within report 132, whether particular threshold or deductible conditions either have been or need to be met. For example, the cumulative total, described above, may be compared to a predetermined threshold, and a statement indicating that the cumulative total exceeds that threshold included in the report. Such conditions may also identify unreimbursed medical expenses that have or must reach a minimum dollar amount. Such information is valuable to a patient or customer and as such enhances the value of the service to the customer.

While in the examples given herein the system 1 collates expenditure information from multiple local 133 and remote 134 organizations and provides a consolidated report 132 that includes tax treatment identification information for services provided by the multiple organizations for a group of individuals such as a patient, spouse and dependents, the present invention may be used in any context where multiple customers incur charges from multiple sources.

What is claimed is:

1. A system for creating records identifying items supporting tax determination, comprising:
an input processor for receiving information identifying a service provided to a specific entity and to be at least partially paid for by said specific entity;
a data processor for automatically,
identifying a type of said service identified in said received information and
allocating a predetermined tax related identification code to said service based on service type and incorporating said allocated code, together with information identifying said service in data representing a record; and
an output processor for processing said data representing said record for output in response to user command.

2. A system according to claim 1, wherein
said data processor automatically identifies said type of said service from different types of services subject to potentially different taxation treatment and provided to said specific entity, said different types of services including at least one of, (a) medical services, (b) dental services, (c) education services and (d) dependent care expenses.

3. A system according to claim 1, wherein
said input processor receives mileage information involved in obtaining said service by said specific entity,
said data processor incorporates said mileage information together with said predetermined tax related identification code and said information identifying said service in said data representing a record.

4. A system according to claim 1, wherein
said input processor receives information identifying a plurality of services provided to a specific entity by multiple different organizations,
said data processor,
identifies said type of said services identified in said received information and
allocates predetermined tax related identification codes to said services based on service type and incorporates said allocated codes, together with said information identifying said services, in data representing said record.

5. A system according to claim 1, wherein
said specific entity comprises a specific person,
said input processor receives information identifying a plurality of services provided to a plurality of people associated with said specific person,
said data processor,
identifies said type of said services provided to said plurality of people identified in said received information and
allocates predetermined tax related identification codes to said services based on service type and incorporates said allocated codes, together with said information identifying said services provided to said plurality of people, in data representing said record.

6. A system according to claim 1, wherein
said plurality of people are related to said specific person and said services provided to said plurality of people potentially affect tax payable by said specific person.

7. A system according to claim 1, wherein
said system is employed in processing expenditure records associated with at least one of, (a) a credit card and (b) a debit card, and
said record for output comprises a statement to said specific entity.

8. A system according to claim 1, wherein
said data processor incorporates said allocated code in said data representing said record without manual intervention and said code identifies said service from different types of services subject to potentially different taxation treatment and provided to said specific entity.

9. A system according to claim 8, wherein
said different types of services comprise an outpatient service and an inpatient service.

10. A system according to claim 1, wherein
said specific entity comprises at least one of (a) a patient, (b) a healthcare provider organization, (c) an individual person and (d) a group of physicians and wherein
said data processor automatically searches for information identifying other services also provided to said specific entity and incorporates data identifying said other services together with associated allocated tax related identification codes in said record.

11. A system according to claim 10, wherein
said data processor periodically collates data identifying said other services together with associated allocated tax related identification codes in said record and processes said record for output in at least one form selected from (a) electronic form, (b) a printed report form and (c) a file suitable for communication via the internet.

12. A system according to claim1, wherein
said data processor accumulates information identifying payments made by said specific entity and information identifying services associated with said payments.

13. A system for use in processing expenditure records associated with a credit or debit card, comprising:
an input processor for receiving information identifying a service provided to a specific entity and to be at least partially paid for by said specific entity;
a data processor for automatically,
identifying a type of said service identified in said received information and
allocating a predetermined tax related identification code to said service based on type and incorporating said allocated code, together with information identifying said service, in data representing a statement; and
an output processor for processing said data representing said statement for output in response to user command.

14. A system for creating records identifying items supporting tax determination, comprising:
an input processor for receiving information identifying a service provided to a specific entity and to be at least partially paid for by said specific entity;
a data processor for,
identifying a type of service identified in said received information,
determining, based on identified service type, a predetermined tax related identification code identifying said service from different types of services subject to potentially different taxation treatment, and
allocating said determined tax related identification code to said service based on service type and incorporating said allocated code, together with information identifying said service, in data representing a record; and
an output processor for processing said data representing said record for output in response to user command.

15. A system according to claim 14, wherein
said data processor incorporates said allocated code in said data representing said record without manual intervention.

16. A system according to claim 14, wherein
said data processor adds an expenditure value associated with said service to a cumulative total for a plurality of services to provide a new cumulative total, and determines if said new cumulative total exceeds a predetermined threshold.

17. A system according to claim 16, wherein
said data processor includes in said data representing said record information indicating that said new cumulative total exceeds said predetermined threshold.

18. A method for creating records identifying items supporting tax determination, comprising the activities of:
receiving information identifying a service provided to a specific entity and to be at least partially paid for by said specific entity;
automatically identifying a type of said service identified in said received information;
automatically allocating a predetermined tax related identification code to said service based on service type and incorporating said allocated code, together with information identifying said service, in data representing a record; and
processing said data representing said record for output in response to user command.

19. A method for use in processing expenditure records associated with a credit or debit card, comprising the activities of:
receiving information identifying a service provided to a specific entity and to be at least partially paid for by said specific entity;
automatically identifying said type of said service identified in said received information;
automatically allocating a predetermined tax related identification code to said service based on type and incorporating said allocated code, together with information identifying said service, in data representing a statement; and
processing said data representing said statement for output in response to user command.

20. A method for creating records identifying items supporting tax determination, comprising the activities of:
receiving information identifying a service provided to a specific entity and to be at least partially paid for by said specific entity;
identifying a type of said service identified in said received information;
determining, based on identified service type, a predetermined tax related identification code identifying said service from different types of services subject to potentially different taxation treatment;
allocating said determined tax related identification code to said service based on service type and incorporating said allocated code, together with information identifying said service, in data representing a record; and
processing said data representing said record for output in response to user command.
